(19) United States
(12) Patent Application Publication
(10) Pub. No.: US 2012/0007806 A1
(43) Pub. Date: Jan. 12, 2012

(54) MULTIFUNCTIONAL MOUSE, COMPUTER SYSTEM, AND INPUT METHOD THEREOF

(75) Inventor: Man-Tian LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/916,595

(22) Filed: Oct. 31, 2010

(30) Foreign Application Priority Data
Jul. 8, 2010 (CN) 201010221173.8

(51) Int. Cl. G06F 3/033

(52) U.S. Cl. 345/166

(57) ABSTRACT

A multifunctional optical mouse includes a first light sources, a second light source, an orientation detecting unit, a transparent touch input area, an imaging unit and a processing unit. The second light source is arranged along a side of the transparent touch input area. The system includes a multifunctional optical mouse, and a computer. The system is switched between a mouse mode and a touch input mode according to the orientation of the mouse. The present disclosure also provides an input method applied in the computer system.

### BACKGROUND

1. Technical Field

The present disclosure relates to computer peripheral devices and, particularly, to a multifunctional mouse, a computer system using the multifunctional mouse, and an input method thereof.

2. Description of Related Art

Some computer mice include a built-in writing pad and a user can switch back and forth between a mouse mode and a touch input mode. However, mice with built-in writing pads are expensive.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of a computer system in accordance with an exemplary embodiment including a mouse of the computer system in an inverted orientation.

FIG. 2 is a block diagram of the computer system in accordance with an exemplary embodiment.

FIG. 3 is a flowchart of an input method in accordance with an exemplary embodiment.

### DETAILED DESCRIPTION

Embodiments of the present disclosure will now be described in detail below, with reference to the accompanying drawings.

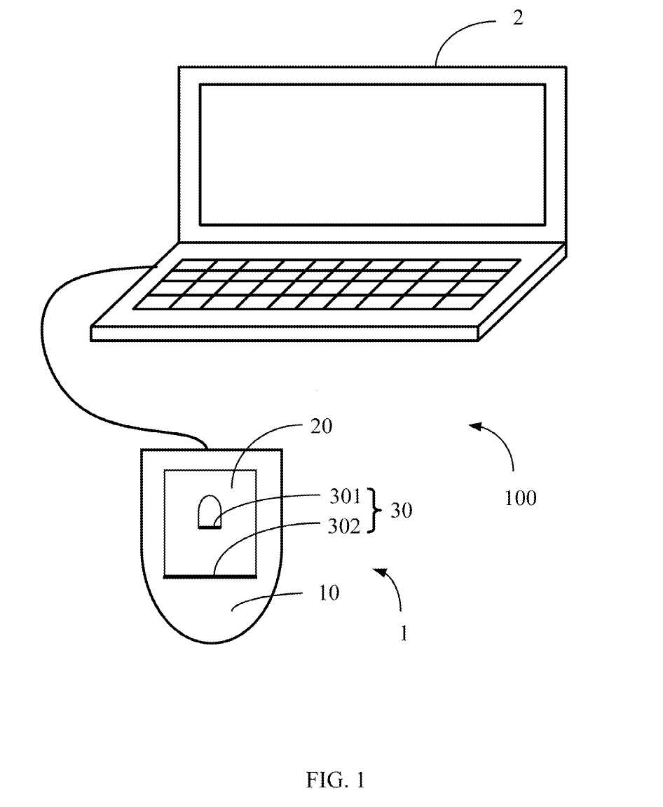

Referring to FIG. 1, a computer system 100 includes a multifunctional optical mouse 1 and a computer 2. The computer 2 communicates with the mouse 1.

The mouse 1 includes a shell 10, a touch input area 20, and a set of light sources 30. The touch input area 20 is a transparent layer, which is set on the bottom of the shell 10, that is, the part of the shell that comes into contact with a supporting surface when the mouse 1 is used as a standard mouse. The touch input area 20 may be made of transparent plastic, transparent glass, or the like. The light sources 30 include a first light source 301 and a second light source 302. The first light source 301 is turned on when the mouse 1 is in a mouse mode, that is, when the mouse 1 is used as a standard mouse. The second light source 302 is turned on when the mouse 1 is in a touch input mode and the first light source 301 is turned off, that is, when the mouse 1 is used as a conventional touch pad. In this embodiment, the second light source 302 is strip-shaped and arranged along a side of the touch input area 20.

In this embodiment, the mouse 1 is switched between the mouse mode and the touch input mode according to the orientation of the mouse 1. Whenever the mouse 1 is in a normal orientation in which the mouse 1 is kept upright on a support surface, the mouse 1 is automatically set to the mouse mode. If the mouse 1 is in a inverted orientation, that is the mouse is turned over to expose the input area 20, the mouse 1 automatically switches to the touch input mode.

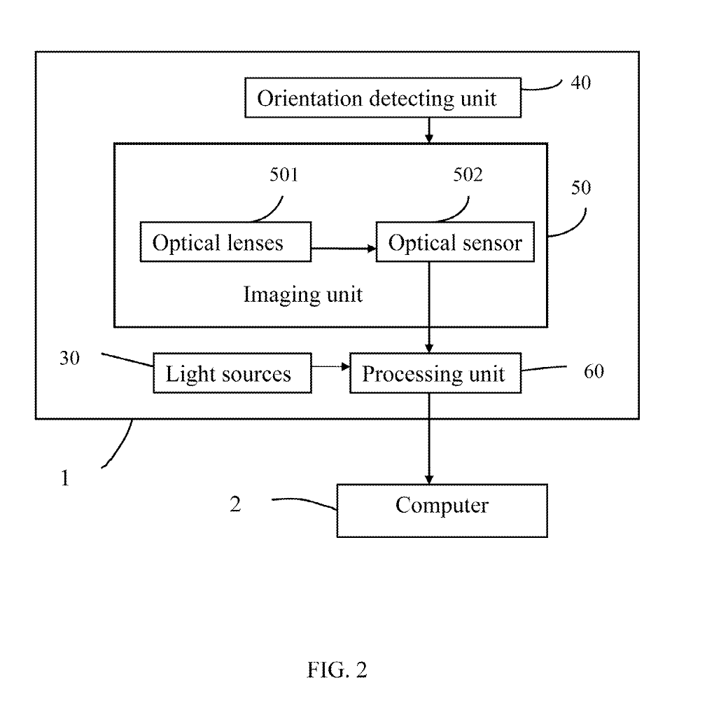

Referring to FIG. 2, in this embodiment, the mouse 1 further includes an orientation detecting unit 40, an imaging unit 50, and a processing unit 60.

The orientation detecting unit 40 is configured for detecting the orientation of the mouse 1. The orientation detecting unit 40 may be a gravity sensor, or a pressure sensor set on the bottom of the multifunctional mouse 1.

The imaging unit 50 includes a set of optical lenses 501 and an optical sensor 502. The imaging unit 50 works much like ordinary optical mice when the mouse 1 is operated as a standard mouse, and is also configured for capturing images of the touch input area 20 when the mouse 1 is in the touch input mode. Specifically, light from the second light source 302 lights up the touch input area 20 so that images of the touch input area 20 can be captured by the optical sensor 502 through the optical lenses 501. When the touch input area 20 is touched by a finger or a stylus, images are automatically captured, and known algorithms are used by the processor 60 to examine the images to determine where the touch or touches occur and paths of sliding touches.

The processing unit 60 is also configured for determining the movement track of the mouse 1 according to the images formed by the optical sensor 502 when the mouse 1 is in the mouse mode.

The computer 2 is configured for executing touch input function according to the determined paths of sliding touches on the touch input area 20 when the mouse 1 is in the touch input mode, and further configured for controlling the movement of the cursor displayed on the computer 2 according to the determined movement track of the mouse 1 when the mouse 1 is in the mouse mode.

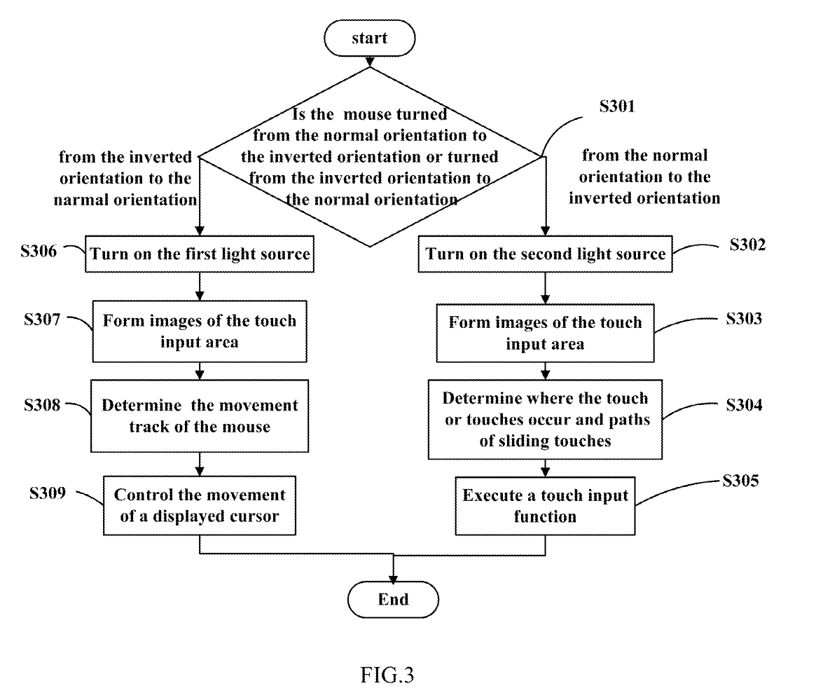

FIG. 3 is a flowchart of an input method in accordance with an exemplary embodiment.

In step S301, the orientation detecting unit 40 determines whether the mouse 1 is turned from the normal orientation to the inverted direction or turned from the inverted direction to the normal direction.

If the multifunctional mouse 1 is turned from the normal orientation to the inverted orientation, the procedure goes to step S302, otherwise the procedure goes to step S306.

In step S302, the mouse 1 turns on the second light source 302.

In step S303, the imaging unit 50 captures images of the touch input area 20.

In step S304, the processing unit 60 examines the images to determine where the touch or touches occur and paths of sliding touches.

In step S305, the computer 2 executes touch input function according to the determined paths of sliding touches on the touch input area 20.

In step S306, the mouse 1 turns on the first light source 301.

In step S307, the imaging unit 50 captures images of the touch input area 20.

In step S308, the processing unit 60 determines the movement track of the mouse 1 according to the images.

In step S309, the computer 2 controls the movement of a displayed cursor according to the determined movement track of the mouse 1.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A multifunctional optical mouse comprising:
a shell;
an orientation detecting unit configured to determine whether the mouse is turned from a normal orientation to an inverted orientation or turned from the inverted direction to the normal orientation, wherein, when the mouse is in the normal orientation, the mouse is in a mouse mode, and when the mouse is in the invented orientation, the mouse is in a touch input mode;
a transparent touch input area set on a bottom of the shell;
a first light source being turned on when the mouse is in the mouse mode;
a second light source being turned on when the mouse is in the touch input mode;
an imaging unit configured to form images of the transparent touch input area; and
a processing unit configured to examine the images to determine where the touch or touches occur and paths of sliding touches on the touch input area when the mouse is in the touch input mode, and further configured to determine a movement track of the mouse when the mouse is in the mouse mode.

2. The mouse according to claim 1, wherein the orientation detecting unit is a gravity sensor or a pressure sensor.

3. The mouse according to claim 1, wherein the second light source is strip-shaped and arranged along a side of the transparent handwriting input area.

4. The mouse according to claim 1, wherein the transparent touch input area is made of transparent plastic or transparent glass.

5. A computer system comprising:
a computer; and
a multifunctional optical mouse communicating with the computer, the mouse comprising:
a shell;
an orientation detecting unit configured to determine whether the mouse is turned from a normal orientation to an inverted orientation or turned from the inverted direction to the normal orientation, wherein, when the mouse is in the normal orientation, the mouse is in a mouse mode, and when the mouse is in the invented orientation, the mouse is in a touch input mode;
a transparent touch input area set on a bottom of the shell;
a first light source being turned on when the mouse is in the mouse mode;
a second light source being turned on when the mouse is in the touch input mode;
an imaging unit configured to form images of the transparent touch input area;
and
a processing unit configured to examine the images to determine where the touch or touches occur and paths of sliding touches on the touch input area when the mouse is in the touch input mode, and further configured to determine a movement track of the mouse when the mouse is in the mouse mode; and
the computer configured to execute touch input function according to the determined paths of sliding touches on the touch input area when the mouse is in the touch input mode, and further configured to control the movement of the cursor displayed on the screen of the computer according to the determined movement track of the mouse when the mouse is in the mouse mode.

6. The computer system according to claim 5, wherein the orientation detecting unit of the mouse is a gravity sensor or a pressure sensor.

7. The computer system according to claim 5, wherein the second light source of the mouse is strip-shaped and arranged along a side of the transparent touch input area.

8. The computer system according to claim 5, wherein the transparent touch input area of the mouse is made of transparent plastic or transparent glass.

9. An input method applied in a computer system, the computer system comprising a computer and a multifunctional optical mouse, the mouse comprising a transparent touch input area, a first light source and a second light source, the method comprising:
determining that the multifunction mouse is turned from a normal orientation to an inverted orientation or turned from an inverted orientation to the normal orientation;
turning on the second light source if the mouse is turned from the routine orientation to the inverted orientation;
capturing images of the touch input area;
determining where the touch or touches occur and paths of sliding touches on the touch input area; and
executing a touch input function.

10. The input method according to claim 9, further comprising:
turning on the first light source if the multifunction mouse is turned from the inverted orientation to the normal orientation;
capturing images of the touch input area;
determining a movement track of the mouse; and
controlling movement of a displayed cursor according to the movement track of the mouse.
